(19) United States
(12) Patent Application Publication
(10) Pub. No.: US 2014/0025804 A1
(43) Pub. Date: Jan. 23, 2014

(54) FLOW ROUTING PROTOCOL BY QUERYING A REMOTE SERVER

(71) Applicants: Bruno Mongazon-Cazavet, Nozay (FR); Francois Taburet, Nozay (FR)

(72) Inventors: Bruno Mongazon-Cazavet, Nozay (FR); Francois Taburet, Nozay (FR)

(73) Assignee: ALCATEL-LUCENT, Paris (FR)

(21) Appl. No.: 14/005,371

(22) PCT Filed: Mar. 2, 2012
(86) PCT No.: PCT/EP12/53649

§ 371 Date: Oct. 4, 2013

(30) Foreign Application Priority Data
Apr. 11, 2011 (FR) 1153133

(51) Int. Cl. H04L 12/801

(52) U.S. Cl. CPC H04L 47/10
USPC 709/223

(57) ABSTRACT

The transmission of flows are formed of data packets, by a communication host possessing a set of output points enabling the transmission of the flows. The flows are routed to one point from among the set of output points based on routing information determined by characteristics of the flows wherein a remote server is queried in order to receive at least part of the routing information.

The present invention relates to flow routing within an Internet communication network. These communication networks rely on the TCP/IP protocol suite.

Historically, they have been based on packet routing: each packet is routed independently within the network until it reaches the final destination, which is responsible for correctly assembling the packets in order to reconstruct the initial data. Additionally, there is no connection between the nature of the transported data and the routing.

The need has arrived to create this connection in order to tell some types of traffic apart from others, particularly based on the nature of the traffic (video stream, HTTP transactions, etc.) and on the access network (Wi-Fi, 3G, Ethernet, FemtoCell, etc.)

This need has led to the creation of a family of mechanisms that can be used to refine routing with granularity based on the packet flow, rather than the packet considered individually. These mechanisms are generally called “IP Flow Routing”.

They particularly apply to radio access technologies. The operators of such networks might wish to transmit only one type of traffic. For example, an LTE (for “Long Term Evolution”) network may give preference to transmitting voice over IP (or VOIP) traffic rather than HTTP (HyperText Transfer Protocol) traffic, while the opposite choice might be made for a Wi-Fi network, as specified by the IEEE 802.11 standard.

The hosts themselves may need to make this determination to choose one access network rather than another in order to transmit a data flow. For example, a two-mode communication terminal may give priority to an LTE access network for voice or video traffic, and a Wi-Fi access network for other types of traffic.

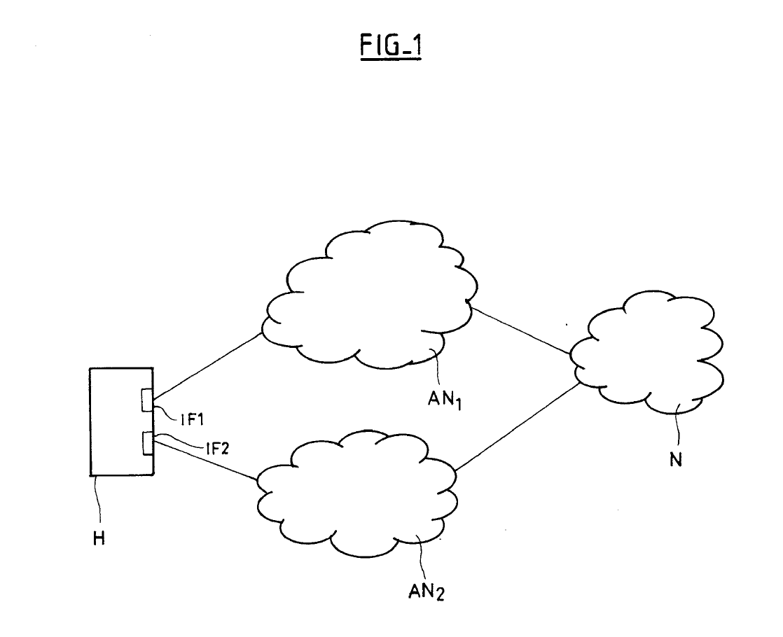

This determination and the control of the routing based on the type of flow is possible with some operating systems, such as the “Linux Advanced Routing and Traffic Control” (LARTC) module. FIG. 1 shows a diagram of the mechanism offered by LARTC.

A host H interfaces with two access networks AN1 and AN2. The access networks are themselves connected to the Internet network N. The host H possesses an interface IF1 with the access network AN1 and an interface IF2 with the access network AN2.

The host H may therefore communicate with the Internet network N by either one of the access networks AN1, AN2.

It is possible to define routing tables associated with each of these access networks within the host H, as well as routing rules to define the situations in which one or the other of these routing tables is to be used. These mechanisms are, for example, described on the website: http://lartc.org/howto/lartc.rpdb.multiple-links.html

Additionally, the link http://linux-ip.net/html/linux-ip.html explains, in section 4.9, the routing policies within a Linux kernel.

However, this option is insufficient by itself to entirely fulfill the requirements of access networks' operators. It is a static mechanism in which the rules and routing tables are configured within the host H. The changes to these rules and routing tables can only be made locally and in a manner dependent on the host: the formats of the rules, the configuration interfaces, etc. are different based on the hosts' operating systems and based on the implementations.

The present invention therefore aims to improve the situation by enabling access networks' operators to control the routing policies used by the hosts.

The patent application WO2010/097057 proposes an extension of the DHCP protocol that would make it possible to include routing information intended for hosts.

Nonetheless, such an approach requires modifying the DHCP clients and servers to be able to operate. Its deployment cost is therefore very high for the various telecommunications stakeholders.

The invention therefore consists of proposing an alternative that would not necessitate modifying the existing protocol layers, and which therefore has a minimal cost on the implementation of communication networks.

To do so, its first object is a method for transmitting flows composed of data packets by a communication host possessing a set of output points enabling the transmission of the flows, which flows are routed to one point from among the set of output points based on routing information determined by characteristics of the flows. This method further comprises
a step of receiving an identifier of a remote server in a response message coming from a dynamic configuration server, and
a step of querying said remote server in order to receive at least part of said routing information.

According to one embodiment of the invention, this method may comprise
a step of the remote server transmitting a notification message to the communication host, which notification message contains routing information and is not requested by the communication host, and
a step of the communication host updating its own routing information based on the routing information contained within the notification message.

It may also comprise a prior step of determining the remote server, triggered when said communication host connects to the access network associated with the remote server.

Subsequent to the receipt of said identifier, the communication host may query a domain name server (of the DNS type) to resolve the identifier and obtain an IP address.

A further object of the invention is a communication host possessing
a set of output points enabling the transmission of flows composed of data packets,
a memory containing routing information,
a routing device for directing the flows to one output point among the set of output points based on routing information determined by the characteristics of the flows,
the host being operative to receive an identifier of a remote server within a response message coming from a dynamic configuration server and
further comprising a protocol client for receiving from that remote server at least part of the routing information.

This way, the routing policy servers may be hosted and controlled by the access networks' operators, which thereby have full control over the rules and policies used by the hosts. These hosts may particularly be managed dynamically: any update on the operator's servers has an immediate impact on any new routing policy request coming from the hosts.

Additionally, the routing policies are communicated on top of the protocol stack used by the access network. This communication therefore no longer depends on the operating systems deployed on the hosts.

Besides the fact that this is an important desire of operators, there is also another advantage in allowing them control of routing policies: they have a better view of what the network is capable of transmitting or not transmitting, both from a static viewpoint (technology, configuration, etc.) and from a dynamic one (load measurement, QoS, etc.).

Additionally, the invention is based on the definition of a specific protocol, and on the implementation of a protocol stack and dedicated servers. It does not in any way modify the existing protocol stacks (and particularly not the DHCP clients and servers). It also enables a simple implementation, because only the elements and parameters necessary for the purpose of the invention are to be managed, while an extension of an existing protocol, such as DHCP in the prior art, necessitates following the requirements of that protocol, even if they do not contribute to resolving the problem.

Other advantages and characteristics of the invention will become more clearly apparent in the description of embodiments that follows, in connection with the attached figures.

FIG. 1, already commented on, gives a diagram of an architecture implementing the state of the art.

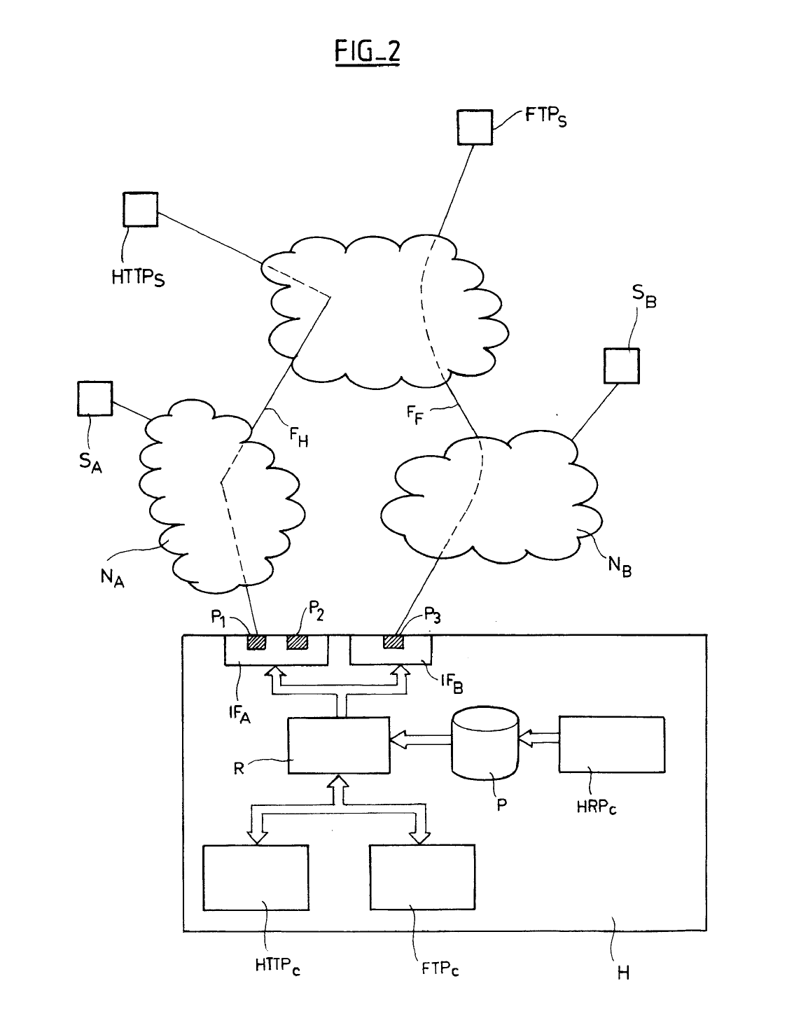

FIG. 2 is a diagram of a network architecture supporting the invention, as well as one possible functional architecture for a communication host according to the invention.

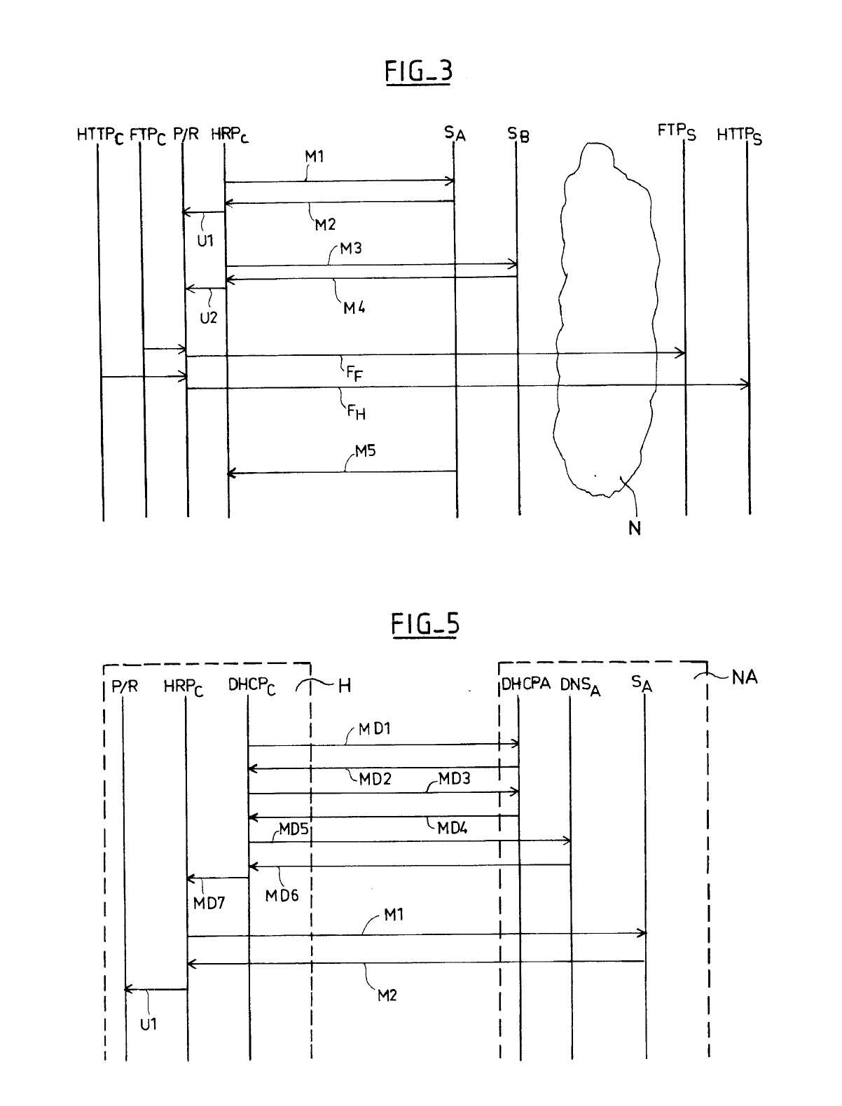

FIG. 3 depicts a time graph illustrating the inventive method.

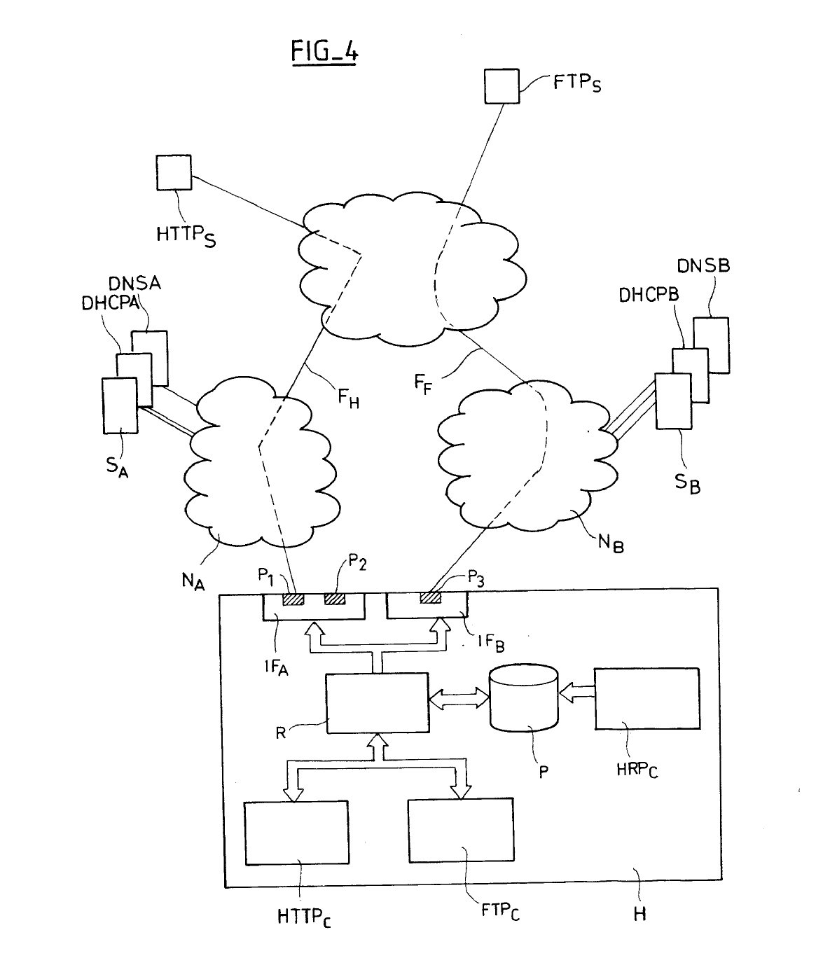

FIG. 4 depicts a network architecture incorporating DHCP and DNS servers, according to one embodiment of the invention.

FIG. 5 depicts a time graph relating to that embodiment.

Generally speaking, an IP host may comprise multiple output points. Each of these output points is associated with an IP address. These output points belong to interfaces, each interface potentially having one or more output points.

In the example in FIG. 2, the communication host H is connected to a core network N by two access networks NA and NB. It comprises two communication interfaces to those access networks, IFA, IFB respectively. The first interface IFA comprises two output points P1, P2 corresponding to two distinct IP addresses. The second interface IFB comprises a single output point P3 corresponding to one IP address.

In the remainder of the description, the presence of the input points within these interfaces will not be mentioned, as they play no particular role in the context of the invention.

In a manner known per se, the communication host H comprises a routing device R and protocol clients HTTPc, FTPc, etc. The role of the routing device is to direct a data packet flow from a protocol client to one of the routing points P1, P2, P3.

This flow routing is carried out for packet flows, and not for each packet considered individually. To do so, the routing device R extracts characteristics of the data flows. This extraction goes beyond “destination address” and “destination port” headers used for routing packets.

The characteristics to be extracted or determined for each packet flow may depend on routing information contained within a memory P of the communication host H.

There has been some work intended to define the fields that may be used to select the data packet flows. For example, one may cite RFC 2280, “Routing Policy Specification Language” and RFC 6080, “Traffic Selectors for Flow Bindings”.

This deep extraction might be carried out entirely for just the first packet of a flow, in order to determine its characteristics and whether it meets the conditions set by a routing rule. For subsequent packets, it may suffice to determine whether it belongs to the flow. To do so, an analysis of a more limited number of the IP packet's headers may be sufficient. Typically, such an identification may be carried out based on a 5-tuple formed of the source and destination addresses and ports, as well as the identifier of the protocol used (i.e. TCP, UDP, etc.).

According to one embodiment of the invention, this routing information might be composed of routing tables and routing rules.

Multiple routing tables may thereby be available for the routing device R. The routing rules may indicate which routing table applies, depending on the characteristics of the packet flows.

The characteristics are directly or indirectly derived from the packets' headers. These headers are generally headers of the IP layer, but more complex mechanisms may be implemented, requiring that other protocol layers be explored.

These techniques may be those known by the term “Deep Packet Inspection” (DPI), which consists of going beyond the IP header to explore the packet's content.

It may also be possible to determine characteristics that aggregate multiple headers or derive from one or more headers. In one embodiment based on the “Advanced Routing” mechanism of the Linux operating system, these rules are stored in a part of the memory P known as “Routing Policy DataBase” (RPDB). The rules control the order in which the routing device R performs a search within the routing tables. Each rule has a priority.

When the first packet of a flow is sent, the routing protocol R browses through all the rules in order of priority and stops this browsing when it encounters a rule whose “if” parts are fulfilled by the flow to be routed.

The routing device then applies the rule. Typically, this involves using a particular routing table designated by that rule, and searching it for a route, but other options are also possible.

### Example of Flow Routing Based on a Protocol Characteristics

In the example of FIG. 2, two protocol clients HTTPc and FTPc may send data packet flows to two protocol servers, respectively HTTPs and FTPs, and receive data flows in response, which also comply with the HTTP (HyperText Transfer Protocol) and FTP (File Transfer Protocol) protocols.

To transmit their data packet flows, the two protocol clients HTTPc and FTPc communicate with the routing device R. Routing information has been provided within the memory P to route these two flows differently. This routing information may take the form of rules, and potentially a routing table.

For example, the memory P may comprise the following two rules (expressed in pseudo-natural language for the sake of comprehension):
IF protocol=HTTP; route=IFA
IF protocol=FTP; route=IFB

These two rules express that the flows corresponding to an HTTP session are routed to the interface IFA, and will therefore reach the server HTTPs by the access network NA, and that the FTP flows are routed to the IFB interface and will therefore reach the server FTPs via the access network NB.

Another embodiment consists of having within the memory P two rules and two routing tables TH and TF.

The two rules may have the format:
IF protocol=HTTP; route=TH
IF protocol=FTP; route=TF

Rather than indicate an output interface, this implementation makes it possible to indicate a routing table to be used: the table TH for the HTTP protocol, and the table TF for the FTP protocol.

Naturally, other embodiments and structures of the memory P are possible.

The determination of the protocol used by a given flow may be carried out by determining the value of the “Protocol” field of the IP header.

It is thereby possible to route the FTP traffic and HTTP traffic in different ways, optimally taking into account advantages and technical characteristics of the access networks NA and NB.

Querying a Rules Server (HRP protocol)

Furthermore, the host H has a protocol client HRPc for receiving from a remote server SA, SB at least part of the routing information stored within the memory P.

It may be provided that routing information be saved within the memory P by other means, and that only part of the routing information comes from one or more remote servers.

According to one preferred embodiment, there is one server for each access network. This way, each network operator has control over its own server, and may thereby manage the routing information that is transmitted to the communication hosts. In this manner, in the example of FIG. 2, the access network NA is associated with a server SA and the access network NB is associated with a server SB.

The servers SA, SB conventionally have an interface for receiving requests from the communication hosts and for sending a response to those hosts. They additionally have a database associating routing information with output point identifiers (i.e., typically with IP addresses).

FIG. 3 depicts a typical implementation cycle of the protocol of the invention.

This protocol may be called HRP for “Host Routing Policy”. It consists of multiple types of messages: a request message, a response message, and potentially a notification message.

These messages may be transported by different transport protocols, such as UDP or TCR

First, the protocol client HRPc of the communication host H transmits a message M1 to the server SA, for its output point p1.

This message may contain an identifier of the message type. This identifier may simply indicate whether it is a request in accordance with the HRP protocol of the invention.

It may contain an exchange identifier, enabling a correlation between the request and response by the communication host H.

It may also contain other parameters.

For example, a parameter may indicate that the request emanates from a communication host. It may in fact be provided that a server may use the same protocol to query another server, and that the servers may thereby exchange routing information.

This may make it possible to easily have multiple servers for the same access network in order to enable load balancing. The updates may thereby be distributed to all of the servers by that querying mechanism between servers.

A server may potentially even query another server to copy another one's entire database, particularly when booting up.

When that message M1 is received, the server SA may use the identifier of output point p1 from which the message M1 had been sent by the host H. This identifier may simply be the IP address contained within the “source address” header of the IP packet encapsulating the message Ml.

Other identifiers may be used. In particular, the identifier may be determined by the communication host H and transmitted as a parameter of the request message M1.

Based on that identifier, the server SA may query its database to retrieve associated routing information. This routing information may be directly used as a response to the communication host H, or it may provide primary information from which secondary information may be derived that is provided as a response to the host. It may even be provided that the server has a processing device that builds or derives routing information on the fly based on primary information “templates”) and on the identifier of the host's output point.

The response M2 sent to the communication host H may contain:
an identifier of the type of message. This identifier may indicate whether it is a response message of the HRP protocol.
An exchange identifier that must be the same as the one contained within the message M1. The communication host may thereby correlate the two messages M1 and M2 and understand that the received message M2 is the response to the sent message M1.
Routing information.

This routing information may be distributed across multiple response messages M2. If so, each response message must contain the same exchange identifier. They may also contain a flag indicating that other response messages follow.

When that message M2 (or those messages) is/are received, the protocol client HRPc sends updates U1 to the memory P. In FIG. 3, the memory P is combined with the routing device R for simplicity's sake.

According to one embodiment of the invention, the routing information may be rules. These rules may define only what is authorized on the interface point in question. By default, whenever is not explicitly authorized by a rule is therefore prohibited.

The host H may structure the received information in different ways. In particular, it may structure all or some of the received routing information in the form of a routing table.

According to one preferred embodiment, a request to a server must be sent for each output point p1, p2, p3 of the communication host H.

The protocol client HRPc may therefore also send another request message for the output point p2 to the same server SA. This message, as well as the response message, are not depicted in FIG. 3. There similar to the messages M1 and M2 and only differ by the values of the content.

The protocol client HRPc sends another request message M3 for the third output point p3 belonging to the interface IFB. This request is sent to the server SB associated with the access network NB. This server SB, similar to the server SA, responds to the communication host H with a response message M4 containing routing information determined based on a database.

When this response message M4 is received, the protocol client HRPc sends an update U2 to the memory P associated with the routing device R.

This routing device R may then process the flows with this updated routing information.

In the example of FIGS. 2 and 3, it is assumed that the server SA transmits a rule specifying that it accepts HTTP traffic. The server SB, meanwhile, transmits a rule specifying that it accepts FTP traffic.

Such rules may have the format:
IF protocol=FTP; route=IFB/p3
IF protocol=http; route=IFA/p1

The routing device therefore transmits the FTP flow F_{E} to that output point p3. It traverses the access network NB before reaching the core network N and the server FTPs. The flow HTTP F_{H} is routed to the output point p1. It traverses the access network NA before reaching the core network N and the server HTTPs.

In one embodiment of the invention, the host H may have means for resolving problems related to the consistency of the routing information that is conveyed to it through these different output points.

### Notification

Furthermore, the servers SA, SB may transmit routing information to the communication hosts, other than by the hosts' request. In most cases, it is believed that the communication hosts transmit these requests when they connect to the access network, but it may also be provided that the access networks' operators make changes to their routing policies and may modify the database associated with the server.

In view thereof, the HRP protocol may comprise a notification message. A notification message is characterized by its being transmitted at a server's initiative, without being requested by the communication host. They may be transmitted to one host in particular, or to all of a server's known hosts.

In this latter case, one implementation may consist of transmitting the notification to a specific multicast address for this mechanism. Another implementation consists of having within the server a memory for storing the addresses of the communication hosts with which the server will exchange messages, and to refer to it when a global notification is to be sent.

In the example of FIG. 3, the server SA transmits a notification message M5 to the communication host H.

This notification message may contain:
an identifier of the type of message. This identifier may indicate whether it is a notification message of the HRP protocol.
Routing information.
An event type which describes the purpose of the notification (for example, addition or deletion)

When it is received, the protocol client HRPc may send an update U3 of the memory R.

### Determining a Routing Rules Server

Multiple implementations are possible in order to enable a communication host H to know the address of a server SA, SB, from which it may obtain the routing information.

Its address (or other identification) may be configured locally by the host's administrator.

Another implementation may consist of the communication host sending a request to a predetermined multicast address so that a server can respond to it and thereby establish a host-server connection. This request may be sent when the communication host H connects to the access network NA, NB.

Another implementation may consist of obtaining the identifier of the remote server within a response message coming from a dynamic address allocation server.

Such an implementation is illustrated by FIG. 4. This FIG. 4 repeats the devices depicted by FIG. 2, and adds dynamic configuration servers DHCPA, DHCPB, and domain name servers, DNSA, DNSB.

These dynamic configuration servers typically comply with RFC 2131, “Dynamic Host Configuration Protocol”. Such a server is generally known by the term “DHCP server”.

The dynamic configuration servers DHCP are typically used to make it possible to dynamically configure a host transparently, without the intervention of an administrator or even the host's user. When it connects to a communication network, standardized exchanges enable the host H to automatically acquire the information that is essential to communicate with that communication network. The essential information generally includes the IP address that that host must use for its communications.

According to the invention, the host H may also acquire the identifiers of the remote servers SA, SB thanks to this mechanism and the use of this type of server.

FIG. 5 depicts the exchanges between the host H and the access network NA. The same type of exchange is instituted with the access network NB.

A first message MD1 may be sent by a protocol client DHCPc contained within the host H to the server DHCPA. This message MD1 may be transmitted when the host H connects to the access network NA. It may be a “DISCOVER” message in accordance with the DHCP protocol according to RFC 2131.

In response, the server DHCPA transmits a message MD2 containing an IP address that the host may use to communicate with the access network NA.

The protocol client DHCPc may then transmit a message MD3, using this IP address, containing an option field specifying that it desires an identifier of a remote server. This option field is a character string. In order to deploy the invention within a public network, this option field must be the subject of a standardization request filed with the IANA. This string may, for example, be HRP-FQDN-OPT″, the FQDN protocol being defined within RFC 4703 of the IETF.

In a manner known per se, it may also include an option field specifying that it desires an identifier of a DNS name server (Domain Name Server).

This message may be a “REQUEST” message in accordance with RFC 2131.

The dynamic configuration server DHCPA may then send a response message MD4. This response message may be a “REPLY” message in accordance with RFC 2131. It may contain an identifier of a DNS domain name server (for example, its IP address).

It may also contain an identifier of the remote server SA. This identifier may be the IP address of the remote server SA. It may alternatively be a FQDN (Fully Qualified Domain Name) logical identifier in accordance with RFC 1035 of the IETF.

This identifier may be contained within an option field of the MD4 message in accordance with the DHCP protocol. This field may be a “HRP FQDN Option” field of that “REPLY” message. It may comprise an identifier of the field, a length, and a value. This value may comply with the recommendations of RFC 1035 of the IETF, entitled “Domain Names—Implementation and Specification”.

If the configuration server DHCPA is not operative to manage this extension according to the invention, or if no information is available for that host, it may, for example, not return any “HRP FQDN option” within the message MD4, or it may return a “HRP FQDN Option” field with a null length.

It is possible for the hosts H to include a “HRP FQDN Option” field within subsequent requests to the configuration server DHCPA. In this situation, the configuration server may return the value, and this value may potentially differ from the initial value for different reasons (reconfiguration of the access network NA, etc.)

When this message MD4 is received, the protocol client DHCPc may send a request MD5 to a domain name server DNSA (whose identifier had previously been provided by the configuration server DHCPA) in order to resolve the received FQDN identifier.

Conventionally, the name server DNSA returns a response message MD6 containing the IP address corresponding to that FQDN identifier.

The protocol client DHCPc may send the received IP address to the protocol client HRPc by a message MD7 internal to the communication host H. The format of this internal message depends on the architecture of the host H and on the API programming interfaces of the various protocol clients. Different implementations are possible and easily accessible to the person skilled in the art.

The protocol client HRPc may then transmit a request M1 to the remote server SA, receive a response M2 and update the memory P via an update message U1, as has already been explained for FIG. 3. As stated previously, the same exchanges may take place for the access network NB.

Generally speaking, in Ipv4, the option field “HRP FQDN”, or an equivalent, may be inserted into the DHCP messages “Discover” and “Request” by a communication host. A dynamic configuration server DHCP may insert an “HRP FQDN” option field including a value representative of the remote server's identifier (and a field length) in the DHCP “Reply” messages sent to the communication host H.

In Ipv6, a client may insert an “OPTION_IA_HRP_FQDN” option into a DHCPv6 Option Request Option header, as defined by RFC 3315 of the IETF, in the “Solicit”, “Request”, “Renew”, “Rebind”, “Information-Request” and “Reconfigure” messages.

The dynamic configuration server DHCP may insert the remote server's identifier into a specific option field which contains an option code (which must be standardized by the IANA), a field length, and a value representative of that identifier.

1. A method for transmitting flows composed of data packets, by a communication host possessing a set of output points enabling the transmission of said flows, said flows being routed to one point from among said set of output points based on routing information determined by characteristics of said flows, wherein the method comprises:
a step of receiving an identifier of a remote server within a response message from a dynamic configuration server,
a step of querying said remote server in order to receive at least part of said routing information.

2. A method according to claim 1, further comprising a step of said remote server transmitting a notification message to said communication host, said notification message containing routing information and not being requested by said communication host, and a step of said communication host updating its own routing information based on the routing information contained within said notification message.

3. A method according to claim 1, comprising a prior step of determining said remote server triggered when said communication host connects to the access network associated with said remote server.

4. A method according to claim 1, wherein, subsequent to the receipt of said identifier, said communication host queries a domain name server in order to resolve said identifier and to obtain an IP address.

5. A communication host possessing a set of output points enabling the transmission of flows composed of data packets, a memory containing routing information, and a routing device for directing said flows to one output point among said set of output points based on routing information determined by the characteristics of said flows, said host being operative to receive an identifier of a remote server within a response message coming from a dynamic configuration server and additionally comprising a protocol client to receive from said remote server at least part of said routing information.

6. A communication host according to claim 5, operative to determine said remote server when said communication host connects to the access network associated with said remote server.

7. A communication host according to claim 6, operative to, subsequent to the receipt of said identifier, query a domain name server in order to resolve said identifier and obtain an IP address.
